(19) United States
(12) Patent Application Publication
(10) Pub. No.: US 2025/0186860 A1
(43) Pub. Date: Jun. 12, 2025

(54) SYSTEM FOR THE TRAINING, TEACHING, AND PRESENTING USING A PLURALITY OF DISPLAY WINDOWS

(71) Applicants: Robert B. Hanson, II, Mobile, AL (US); Robert B. Hanson, III, Mobile, AL (US)

(72) Inventors: Robert B. Hanson, II, Mobile, AL (US); Robert B. Hanson, III, Mobile, AL (US)

(21) Appl. No.: 18/974,781

(22) Filed: Dec. 9, 2024

Related U.S. Application Data
(60) Provisional application No. 63/608,175, filed on Dec. 8, 2023.

(51) Int. Cl. A63B 71/06

(52) U.S. Cl. CPC A63B 71/0622; A63B 2210/50; A63B 2225/11

(57) ABSTRACT

A system for training athletes is provided. Generally, the system is designed to identify users of the system and facilitate communication between users, wherein at least one user is an athlete and at least one user is a mentor of said athlete. The system comprises one or more computing devices having user interfaces, processor operably connected to said one or more computing devices, display operably connected to said processor, and non-transitory computer-readable medium coupled to said processor and having instructions stored thereon.

### CROSS REFERENCES

This application claims priority to U.S. Provisional Application Ser. No. 63/608,175, filed on Dec. 8, 2023, in which application is incorporated herein in its entirety by reference.

### FIELD OF THE DISCLOSURE

The subject matter of the present disclosure refers generally to a system for the training of athletes.

### BACKGROUND

The training and development of athletes has long been a complex and multifaceted process, requiring careful monitoring of various aspects of an athlete's performance, health, and academic progress. Traditionally, coaches and trainers have relied on a combination of in-person observations, periodic assessments, and paper-based record-keeping to track an athlete's progress over time. However, this approach often suffers from limitations in terms of data accuracy, timeliness, and accessibility. One particular challenge in athlete development is the need for real-time, collaborative review of an athlete's progress across multiple domains. Coaches, trainers, nutritionists, and academic advisors often work in silos, with limited ability to share and discuss relevant information in a timely manner. This can lead to missed opportunities for holistic athlete development and potential conflicts in training regimens or schedules. Additionally, the mobile nature of many sports teams and athletic programs presents logistical challenges for consistent progress review and mentoring. Training facilities, competition venues, and academic institutions may be geographically dispersed, making it difficult to conduct comprehensive, in-person reviews on a regular basis.

In recent years, there has been a shift towards digital solutions for athlete monitoring and development. These systems typically involve the use of wearable devices, smartphone applications, and cloud-based platforms to collect and analyze data related to an athlete's physical performance, nutrition, and academic standing. While these digital tools have improved the ability to gather and store relevant information, they often lack the flexibility and immediacy required in dynamic training environments. Furthermore, existing solutions often fail to provide a secure and private environment for sensitive discussions about an athlete's performance, health, or academic standing. This can limit the depth and candor of progress reviews, potentially impacting the effectiveness of mentoring and development efforts.

As athletic programs continue to evolve and embrace technology, there is a growing need for innovative solutions that can address these challenges. A system that combines portability, real-time data access, and secure communication capabilities could significantly enhance the ability of coaches and support staff to effectively monitor and guide athlete development across various domains. The present invention addresses this need. By disclosing a portable system for an enclosed display with access to a database of relevant athlete data, the present invention ensures that athletes are equipped to receive all their appropriate mentorship regardless of locale.

### SUMMARY

A system for training athletes comprising a portable pod, one or more displays, and associated control boards, processors, and other devices is provided. In one aspect, the present invention is a portable structure that enables and facilitates athletic training in a plurality of locales. In another aspect, the present invention is a secure structure that allows athlete-mentor interactions in privacy. In yet another aspect, the present invention is a system for presenting various content relevant to athletic training in a plurality of display windows. In still another aspect, the present invention is a system for managing on-site or remote organization of displays within a structure. Generally, the present invention is a system for enabling athletic training by facilitating the display of various data in a portable pod for athletes and mentors.

The system comprising a portable pod includes a framework operably connected to a hydraulic/pneumatic arm, wherein the hydraulic/pneumatic arm alters the position of the framework. An exterior shell is connected to the framework, forming an exterior structure that protects an internal cavity created by the framework when the hydraulic/pneumatic arm places the framework into an extended position. An opening within the exterior shell allows for access to the internal cavity. Alternatively, the portable pod comprises a first framework operably connected to a first hydraulic/pneumatic arm, wherein the first hydraulic/pneumatic arm alters the position of the first framework. A second framework is operably connected to a second hydraulic/pneumatic arm, wherein the second hydraulic/pneumatic arm alters the position of the second framework. An exterior shell is connected to both the first framework and the second framework, forming an exterior structure. The shape of the exterior structure is manipulated by the position of the first framework relative to the second framework, and an opening within the exterior shell allows for access to an internal cavity created when at least one of the first framework or the second framework are placed in the extended position.

The system also includes a control board configured to manipulate a plurality of display windows of a display user interface, and a display operably connected to the control board. The display is secured in the interior of the internal cavity and is configured to present the display user interface having the plurality of display windows. Content related to athletic training is presented within the plurality of display windows. Additionally, the system includes a processor operably connected to the control board and a non-transitory computer-readable medium coupled to the processor. The non-transitory computer-readable medium contains instructions stored thereon, which, when executed by the processor, cause the processor to perform operations including determining an identity of a user accessing a user profile via the user interface of the control board, retrieving a user profile having user data that pertains to the identity, transmitting a permission level of the user profile to the control board, determining to which content the user has access based on the permission level, presenting data pertaining to the user profile within the plurality of display windows, and organizing the plurality of display windows via the control board.

According to other aspects of the present disclosure, the system may include a hydraulic/pneumatic pack operably connected to the hydraulic/pneumatic arm or arms and the control board, wherein the control board is configured to manipulate the hydraulic/pneumatic pack. The hydraulic/pneumatic pack causes the hydraulic/pneumatic arm or arms to move the framework from a collapsed position to the extended position. The system may further include a computing device having a user interface and operably connected to the control board and the processor. The user interface of the computing device allows a user to control the hydraulic/pneumatic pack such that the user may cause the hydraulic/pneumatic pack to place the framework in the collapsed position and the extended position. Additionally, the computing device may allow a user to transmit image data to the display, wherein the display may present the image data within the display user interface. The system may also include a secondary security device operably connected to the control board, wherein the secondary security device is configured to only communicate with the control board. The secondary security device may be configured to send a computer-readable signal to the control board, which is used by the control board to verify login credentials of a user, wherein the login credentials allow the user to access the display user interface of the display.

The present disclosure may be conceptualized alternatively as a system for a portable pod comprising a plurality of Hoberman linkages. A hydraulic/pneumatic arm is operably connected to the plurality of Hoberman linkages, wherein the hydraulic/pneumatic arm alters the position of the plurality of Hoberman linkages. An exterior shell is connected to the plurality of Hoberman linkages, forming an exterior structure over the plurality of Hoberman linkages to create an isokinetic building structure. An opening within the exterior shell allows for access to an internal cavity created when the plurality of Hoberman linkages are placed in an extended position.

According to other aspects of the present disclosure, the system may include a hydraulic/pneumatic pack operably connected to the control board and to the hydraulic/pneumatic arm, wherein the control board is configured to manipulate the hydraulic/pneumatic pack. The hydraulic/pneumatic pack causes the hydraulic/pneumatic arm to move the plurality of Hoberman linkages from a collapsed position to an extended position. The display, control board, processor, and computing devices function similarly to the aforementioned arrangement.

The foregoing summary has outlined some features of the system and method of the present disclosure so that those skilled in the pertinent art may better understand the detailed description that follows. Additional features that form the subject of the claims will be described hereinafter. Those skilled in the pertinent art should appreciate that they can readily utilize these features for designing or modifying other structures for carrying out the same purpose of the system and method disclosed herein. Those skilled in the pertinent art should also realize that such equivalent designs or modifications do not depart from the scope of the system and method of the present disclosure.

### DESCRIPTION OF THE DRAWINGS

These and other features, aspects, and advantages of the present disclosure will become

better understood with regard to the following description, appended claims, and accompanying drawings where:

FIG. 1 illustrates a system embodying features consistent with the principles of the present disclosure.

FIG. 2 illustrates a system embodying features consistent with the principles of the present disclosure.

FIG. 3 illustrates a system embodying features consistent with the principles of the present disclosure.

FIG. 4 illustrates a system embodying features consistent with the principles of the present disclosure.

FIG. 5 illustrates a system embodying features consistent with the principles of the present disclosure.

FIG. 6 illustrates a system embodying features consistent with the principles of the present disclosure.

FIG. 7 illustrates a system embodying features consistent with the principles of the present disclosure.

FIG. 8 illustrates a system embodying features consistent with the principles of the present disclosure.

FIG. 9 illustrates the manner in which individual access to data may be granted or limited based on user roles and administrator roles.

### DETAILED DESCRIPTION

In the Summary above and in this Detailed Description, and the claims below, and in the accompanying drawings, reference is made to particular features, including method steps, of the invention. It is to be understood that the disclosure of the invention in this specification includes all possible combinations of such particular features. For instance, where a particular feature is disclosed in the context of a particular aspect or embodiment of the invention, or a particular claim, that feature can also be used, to the extent possible, in combination with/or in the context of other particular aspects of the embodiments of the invention, and in the invention generally.

The term “comprises” and grammatical equivalents thereof are used herein to mean that other components, steps, etc. are optionally present. For instance, a system “comprising” components A, B, and C can contain only components A, B, and C, or can contain not only components A, B, and C, but also one or more other components. Where reference is made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility). As will be evident from the disclosure provided below, the present invention satisfies the need for a system for training athletes in a training facility and on an athletics field.

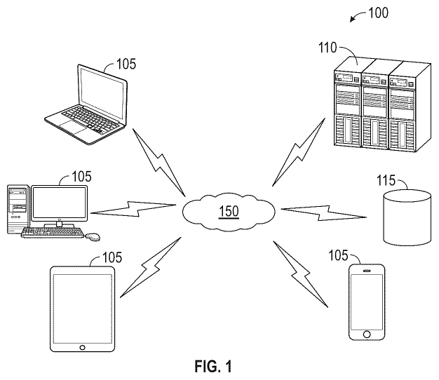

FIG. 1 depicts an exemplary environment 100 of the system 400 consisting of clients 105 connected to a server 110 and/or database 115 via a network 150. Clients 105 are devices of users 405 that may be used to access servers 110 and/or databases 115 through a network 150. A network 150 may comprise of one or more networks of any kind, including, but not limited to, a local area network (LAN), a wide area network (WAN), metropolitan area networks (MAN), a telephone network, such as the Public Switched Telephone Network (PSTN), an intranet, the Internet, a memory device, another type of network, or a combination of networks. In a preferred embodiment, computing entities 200 may act as clients 105 for a user 405. For instance, a client 105 may include a personal computer, a wireless telephone, a streaming device, a “smart” television, a personal digital assistant (PDA), a laptop, a smart phone, a tablet computer, or another type of computation or communication interface 280. Servers 110 may include devices that access, fetch, aggregate, process, search, provide, and/or maintain documents. Although FIG. 1 depicts a preferred embodiment of an environment 100 for the system 400, in other implementations, the environment 100 may contain fewer components, different components, differently arranged components, and/or additional components than those depicted in FIG. 1. Alternatively, or additionally, one or more components of the environment 100 may perform one or more other tasks described as being performed by one or more other components of the environment 100.

As depicted in FIG. 1, one embodiment of the system 400 may comprise a server 110. Although shown as a single server 110 in FIG. 1, a server 110 may, in some implementations, be implemented as multiple devices interlinked together via the network 150, wherein the devices may be distributed over a large geographic area and performing different functions or similar functions. For instance, two or more servers 110 may be implemented to work as a single server 110 performing the same tasks. Alternatively, one server 110 may perform the functions of multiple servers 110. For instance, a single server 110 may perform the tasks of a web server and an indexing server 110. Additionally, it is understood that multiple servers 110 may be used to operably connect the processor 220 to the database 115 and/or other content repositories. The processor 220 may be operably connected to the server 110 via wired or wireless connection. Types of servers 110 that may be used by the system 400 include, but are not limited to, search servers, document indexing servers, and web servers, or any combination thereof.

Search servers may include one or more computing entities 200 designed to implement a search engine, such as a documents/records search engine, general webpage search engine, etc. Search servers may, for example, include one or more web servers designed to receive search queries and/or inputs from users 405, search one or more databases 115 in response to the search queries and/or inputs, and provide documents or information, relevant to the search queries and/or inputs, to users 405. In some implementations, search servers may include a web search server that may provide webpages to users 405, wherein a provided webpage may include a reference to a web server at which the desired information and/or links are located. The references to the web server at which the desired information is located may be included in a frame and/or text box, or as a link to the desired information/document. Document indexing servers may include one or more devices designed to index documents available through networks 150. Document indexing servers may access other servers 110, such as web servers that host content, to index the content. In some implementations, document indexing servers may index documents/records stored by other servers 110 connected to the network 150. Document indexing servers may, for example, store and index content, information, and documents relating to user accounts and user-generated content. Web servers may include servers 110 that provide webpages to clients 105. For instance, the webpages may be HTML-based webpages. A web server may host one or more websites. As used herein, a website may refer to a collection of related webpages. Frequently, a website may be associated with a single domain name, although some websites may potentially encompass more than one domain name. The concepts described herein may be applied on a per-website basis. Alternatively, in some implementations, the concepts described herein may be applied on a per-webpage basis.

As used herein, a database 115 refers to a set of related data and the way it is organized. Access to this data is usually provided by a database management system (DBMS) consisting of an integrated set of computer software that allows users 405 to interact with one or more databases 115 and provides access to all of the data contained in the database 115. The DBMS provides various functions that allow entry, storage and retrieval of large quantities of information and provides ways to manage how that information is organized. Because of the close relationship between the database 115 and the DBMS, as used herein, the term database 115 refers to both a database 115 and DBMS.

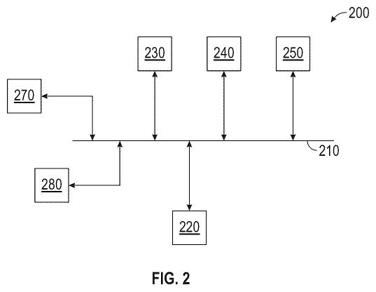

FIG. 2 is an exemplary diagram of a client 105, server 110, and/or or database 115 (hereinafter collectively referred to as “computing entity 200”), which may correspond to one or more of the clients 105, servers 110, and databases 115 according to an implementation consistent with the principles of the invention as described herein. The computing entity 200 may comprise a bus 210, a processor 220, memory 304, a storage device 250, a peripheral device 270, and a communication interface 280 (such as wired or wireless communication device). The bus 210 may be defined as one or more conductors that permit communication among the components of the computing entity 200. The processor 220 may be defined as logic circuitry that responds to and processes the basic instructions that drive the computing entity 200. Memory 304 may be defined as the integrated circuitry that stores information for immediate use in a computing entity 200. A peripheral device 270 may be defined as any hardware used by a user 405 and/or the computing entity 200 to facilitate communicate between the two. A storage device 250 may be defined as a device used to provide mass storage to a computing entity 200. A communication interface 280 may be defined as any transceiver-like device that enables the computing entity 200 to communicate with other devices and/or computing entities 200.

The bus 210 may comprise a high-speed interface 308 and/or a low-speed interface 312 that connects the various components together in a way such they may communicate with one another. A high-speed interface 308 manages bandwidth-intensive operations for computing device 300, while a low-speed interface 312 manages lower bandwidth-intensive operations. In some preferred embodiments, the high-speed interface 308 of a bus 210 may be coupled to the memory 304, display 316, and to high-speed expansion ports 310, which may accept various expansion cards such as a graphics processing unit (GPU). In other preferred embodiments, the low-speed interface 312 of a bus 210 may be coupled to a storage device 250 and low-speed expansion ports 314. The low-speed expansion ports 314 may include various communication ports, such as USB, Bluetooth, Ethernet, wireless Ethernet, etc. Additionally, the low-speed expansion ports 314 may be coupled to one or more peripheral devices 270, such as a keyboard, pointing device, scanner, and/or a networking device, wherein the low-speed expansion ports 314 facilitate the transfer of input data from the peripheral devices 270 to the processor 220 via the low-speed interface 312.

The processor 220 may comprise any type of conventional processor or microprocessor that interprets and executes computer readable instructions. The processor 220 is configured to perform the operations disclosed herein based on instructions stored within the system 400. The processor 220 may process instructions for execution within the computing entity 200, including instructions stored in memory 304 or on a storage device 250, to display graphical information for a graphical user interface (GUI) on an external peripheral device 270, such as a display 316. The processor 220 may provide for coordination of the other components of a computing entity 200, such as control of user interfaces 411, applications run by a computing entity 200, and wireless communication by a communication interface 280 of the computing entity 200. The processor 220 may be any processor or microprocessor suitable for executing instructions. In some embodiments, the processor 220 may have a memory device therein or coupled thereto suitable for storing the data, content, or other information or material disclosed herein. In some instances, the processor 220 may be a component of a larger computing entity 200. A computing entity 200 that may house the processor 220 therein may include, but are not limited to, laptops, desktops, workstations, personal digital assistants, servers 110, mainframes, cellular telephones, tablet computers, smart televisions, streaming devices, or any other similar device. Accordingly, the inventive subject matter disclosed herein, in full or in part, may be implemented or utilized in devices including, but are not limited to, laptops, desktops, workstations, personal digital assistants, servers 110, mainframes, cellular telephones, tablet computers, smart televisions, streaming devices, or any other similar device.

Memory 304 stores information within the computing device 300. In some preferred embodiments, memory 304 may include one or more volatile memory units. In another preferred embodiment, memory 304 may include one or more non-volatile memory units. Memory 304 may also include another form of computer-readable medium, such as a magnetic, solid state, or optical disk. For instance, a portion of a magnetic hard drive may be partitioned as a dynamic scratch space to allow for temporary storage of information that may be used by the processor 220 when faster types of memory, such as random-access memory (RAM), are in high demand. A computer-readable medium may refer to a non-transitory computer-readable memory device. A memory device may refer to storage space within a single storage device 250 or spread across multiple storage devices 250. The memory 304 may comprise main memory 230 and/or read only memory (ROM) 240. In a preferred embodiment, the main memory 230 may comprise RAM or another type of dynamic storage device 250 that stores information and instructions for execution by the processor 220. ROM 240 may comprise a conventional ROM device or another type of static storage device 250 that stores static information and instructions for use by processor 220. The storage device 250 may comprise a magnetic and/or optical recording medium and its corresponding drive.

As mentioned earlier, a peripheral device 270 is a device that facilitates communication between a user 405 and the processor 220. The peripheral device 270 may include, but is not limited to, an input device 408 and/or an output device. As used herein, an input device 408 may be defined as a device that allows a user 405 to input data and instructions that is then converted into a pattern of electrical signals in binary code that are comprehensible to a computing entity 200. An input device 408 of the peripheral device 270 may include one or more conventional devices that permit a user 405 to input information into the computing entity 200, such as a controller, scanner, phone, camera, scanning device, keyboard, a mouse, a pen, voice recognition and/or biometric mechanisms, etc. As used herein, an output device may be defined as a device that translates the electronic signals received from a computing entity 200 into a form intelligible to the user 405. An output device of the peripheral device 270 may include one or more conventional devices that output information to a user 405, including a display 316, a printer, a speaker, an alarm, a projector, etc. Additionally, storage devices 250, such as CD-ROM drives, and other computing entities 200 may act as a peripheral device 270 that may act independently from the operably connected computing entity 200. For instance, a streaming device may transfer data to a smartphone, wherein the smartphone may use that data in a manner separate from the streaming device.

The storage device 250 is capable of providing the computing entity 200 mass storage. In some embodiments, the storage device 250 may comprise a computer-readable medium such as the memory 304, storage device 250, or memory 304 on the processor 220. A computer-readable medium may be defined as one or more physical or logical memory devices and/or carrier waves. Devices that may act as a computer readable medium include, but are not limited to, a hard disk device, optical disk device, tape device, flash memory or other similar solid-state memory device, or an array of devices, including devices in a storage area network or other configurations. Examples of computer-readable mediums include, but are not limited to, magnetic media such as hard disks, floppy disks, and magnetic tape; optical media such as CD ROM discs and DVDs; magneto-optical media such as optical discs; and hardware devices that are specially configured to store and perform programming instructions, such as ROM 240, RAM, flash memory, and the like.

In an embodiment, a computer program may be tangibly embodied in the storage device 250. The computer program may contain instructions that, when executed by the processor 220, performs one or more steps that comprise a method, such as those methods described herein. The instructions within a computer program may be carried to the processor 220 via the bus 210. Alternatively, the computer program may be carried to a computer-readable medium, wherein the information may then be accessed from the computer-readable medium by the processor 220 via the bus 210 as needed. In a preferred embodiment, the software instructions may be read into memory 304 from another computer-readable medium, such as data storage device 250, or from another device via the communication interface 280. Alternatively, hardwired circuitry may be used in place of or in combination with software instructions to implement processes consistent with the principles as described herein. Thus, implementations consistent with the invention as described herein are not limited to any specific combination of hardware circuitry and software.

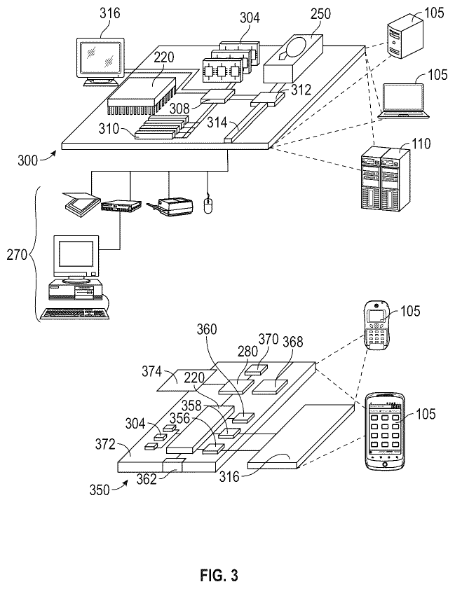

FIG. 3 depicts exemplary computing entities 200 in the form of a computing device 300 and mobile computing device 350, which may be used to carry out the various embodiments of the invention as described herein. A computing device 300 is intended to represent various forms of digital computers, such as laptops, desktops, workstations, servers 110, databases 115, mainframes, and other appropriate computers. A mobile computing device 350 is intended to represent various forms of mobile devices, such as scanners, scanning devices, personal digital assistants, cellular telephones, smart phones, tablet computers, and other similar devices. The various components depicted in FIG. 3, as well as their connections, relationships, and functions are meant to be examples only, and are not meant to limit the implementations of the invention as described herein. The computing device 300 may be implemented in a number of different forms, as shown in FIGS. 1 and 3. For instance, a computing device 300 may be implemented as a server 110 or in a group of servers 110. Computing devices 300 may also be implemented as part of a rack server system. In addition, a computing device 300 may be implemented as a personal computer, such as a desktop computer or laptop computer. Alternatively, components from a computing device 300 may be combined with other components in a mobile device, thus creating a mobile computing device 350. Each mobile computing device 350 may contain one or more computing devices 300 and mobile devices, and an entire system may be made up of multiple computing devices 300 and mobile devices communicating with each other as depicted by the mobile computing device 350 in FIG. 3. The computing entities 200 consistent with the principles of the invention as disclosed herein may perform certain receiving, communicating, generating, output providing, correlating, and storing operations as needed to perform the various method steps below.

In the embodiment depicted in FIG. 3, a computing device 300 may include a processor 220, memory 304 a storage device 250, high-speed expansion ports 310, low-speed expansion ports 314, and bus 210 operably connecting the processor 220, memory 304, storage device 250, high-speed expansion ports 310, and low-speed expansion ports 314. In one preferred embodiment, the bus 210 may comprise a high-speed interface 308 connecting the processor 220 to the memory 304 and high-speed expansion ports 310 as well as a low-speed interface 312 connecting to the low-speed expansion ports 314 and the storage device 250. Because each of the components are interconnected using the bus 210, they may be mounted on a common motherboard as depicted in FIG. 3 or in other manners as appropriate. The processor 220 may process instructions for execution within the computing device 300, including instructions stored in memory 304 or on the storage device 250. Processing these instructions may cause the computing device 300 to display graphical information for a GUI on an output device, such as a display 316 coupled to the high-speed interface 308. In other implementations, multiple processors and/or multiple buses may be used, as appropriate, along with multiple memory units and/or multiple types of memory. Additionally, multiple computing devices may be connected, wherein each device provides portions of the necessary operations.

A mobile computing device 350 may include a processor 220, memory 304 a peripheral device 270 (such as a display 316, a communication interface 280, and a transceiver 368, among other components). A mobile computing device 350 may also be provided with a storage device 250, such as a micro-drive or other previously mentioned storage device 250, to provide additional storage. Preferably, each of the components of the mobile computing device 350 are interconnected using a bus 210, which may allow several of the components of the mobile computing device 350 to be mounted on a common motherboard as depicted in FIG. 3 or in other manners as appropriate. In some implementations, a computer program may be tangibly embodied in an information carrier. The computer program may contain instructions that, when executed by the processor 220, perform one or more methods, such as those described herein. The information carrier is preferably a computer-readable medium, such as memory, expansion memory 374, or memory 304 on the processor 220 such as ROM 240, that may be received via the transceiver or external interface 362. The mobile computing device 350 may be implemented in a number of different forms, as shown in FIG. 3. For example, a mobile computing device 350 may be implemented as a cellular telephone, part of a smart phone, personal digital assistant, or other similar mobile device.

The processor 220 may execute instructions within the mobile computing device 350, including instructions stored in the memory 304 and/or storage device 250. The processor 220 may be implemented as a chipset of chips that may include separate and multiple analog and/or digital processors. The processor 220 may provide for coordination of the other components of the mobile computing device 350, such as control of the user interfaces 411, applications run by the mobile computing device 350, and wireless communication by the mobile computing device 350. The processor 220 of the mobile computing device 350 may communicate with a user 405 through the control interface 358 coupled to a peripheral device 270 and the display interface 356 coupled to a display 316. The display 316 of the mobile computing device 350 may include, but is not limited to, Liquid Crystal Display (LCD), Light Emitting Diode (LED) display, Organic Light Emitting Diode (OLED) display, and Plasma Display Panel (PDP), or any combination thereof. The display interface 356 may include appropriate circuitry for causing the display 316 to present graphical and other information to a user 405. The control interface 358 may receive commands from a user 405 via a peripheral device 270 and convert the commands into a computer readable signal for the processor 220. In addition, an external interface 362 may be provided in communication with processor 220, which may enable near area communication of the mobile computing device 350 with other devices. The external interface 362 may provide for wired communications in some implementations or wireless communication in other implementations. In a preferred embodiment, multiple interfaces may be used in a single mobile computing device 350 as is depicted in FIG. 3.

Memory 304 stores information within the mobile computing device 350. Devices that may act as memory 304 for the mobile computing device 350 include, but are not limited to computer-readable media, volatile memory, and non-volatile memory. Expansion memory 374 may also be provided and connected to the mobile computing device 350 through an expansion interface 372, which may include a Single In-Line Memory Module (SIM) card interface or micro secure digital (Micro-SD) card interface. Expansion memory 374 may include, but is not limited to, various types of flash memory and non-volatile random-access memory (NVRAM). Such expansion memory 374 may provide extra storage space for the mobile computing device 350. In addition, expansion memory 374 may store computer programs or other information that may be used by the mobile computing device 350. For instance, expansion memory 374 may have instructions stored thereon that, when carried out by the processor 220, cause the mobile computing device 350 perform the methods described herein. Further, expansion memory 374 may have secure information stored thereon; therefore, expansion memory 374 may be provided as a security module for a mobile computing device 350, wherein the security module may be programmed with instructions that permit secure use of a mobile computing device 350. In addition, expansion memory 374 having secure applications and secure information stored thereon may allow a user 405 to place identifying information on the expansion memory 374 via the mobile computing device 350 in a non-hackable manner.

A mobile computing device 350 may communicate wirelessly through the communication interface 280, which may include digital signal processing circuitry where necessary. The communication interface 280 may provide for communications under various modes or protocols, including, but not limited to, Global System Mobile Communication (GSM), Short Message Services (SMS), Enterprise Messaging System (EMS), Multimedia Messaging Service (MMS), Code Division Multiple Access (CDMA), Time Division Multiple Access (TDMA), Personal Digital Cellular (PDC), Wideband Code Division Multiple Access (WCDMA), IMT Multi-Carrier (CDMAX 0), and General Packet Radio Service (GPRS), or any combination thereof. Such communication may occur, for example, through a transceiver 368. Short-range communication may occur, such as using a Bluetooth, WIFI, or other such transceiver 368. In addition, a Global Positioning System (GPS) receiver module 370 may provide additional navigation-and location-related wireless data to the mobile computing device 350, which may be used as appropriate by applications running on the mobile computing device 350. Alternatively, the mobile computing device 350 may communicate audibly using an audio codec 360, which may receive spoken information from a user 405 and covert the received spoken information into a digital form that may be processed by the processor 220. The audio codec 360 may likewise generate audible sound for a user 405, such as through a speaker, e.g., in a handset of mobile computing device 350. Such sound may include sound from voice telephone calls, recorded sound such as voice messages, music files, etc. Sound may also include sound generated by applications operating on the mobile computing device 350.

The system 400 may comprise a power supply, which may be any source of power that provides the system 400 with the required energy. In a preferred embodiment, the power supply may be a stationary power source that has been installed in a way such that it is fastened in place, such as a 3-prong wall outlet. In a preferred embodiment, the stationary power source is connected to the wiring system of a premises. In another preferred embodiment, the power supply may be a mobile power source, such as a battery pack, a gas-powered generator, or a fuel cell. In a preferred embodiment, mobile power source does not need to be connected to the wiring system of a premises to provide power to the system but may be capable of connecting to the wiring system of said premises to provide power to a system connected thereto. In another preferred embodiment, the system 400 may comprise multiple power supplies configured to supply power to the system 400 in different circumstances. For instance, the system 400 may be directly plugged into a stationary power source, which may provide power to the system 400 so long as the system does not move out of range of said stationary power source, as well as connected to a mobile power source, which may provide power to the system 400 when the system 400 is not connected to a stationary power source or in situations where the stationary power source ceases to provide power to the system 400. In yet another preferred embodiment, a plurality of solar charging panels may be operably connected to a battery of the system, which may allow a user to place the system 400 in a location that may otherwise have no reasonable access to a stationary power source. In these ways, the system 400 may receive power so that it may be used in the various manners as described herein.

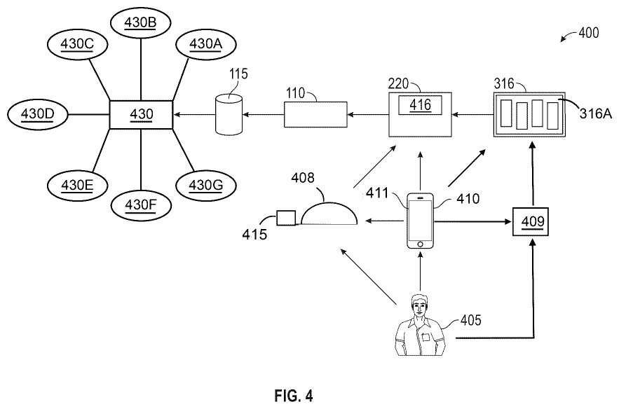

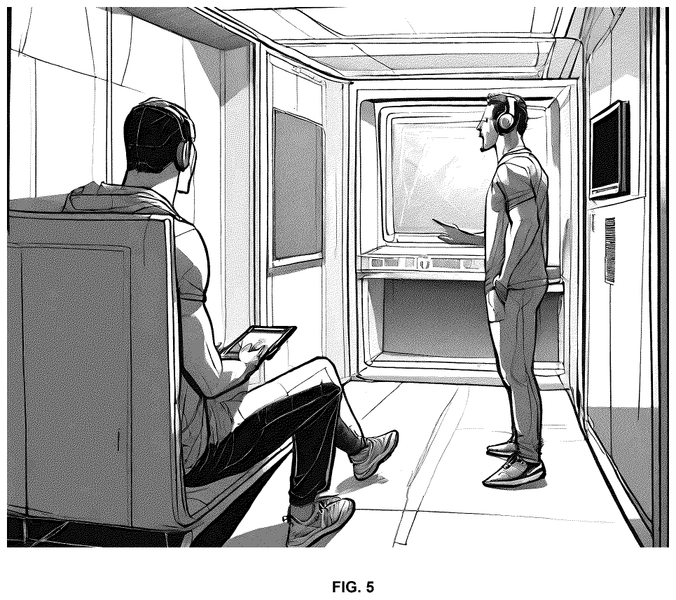

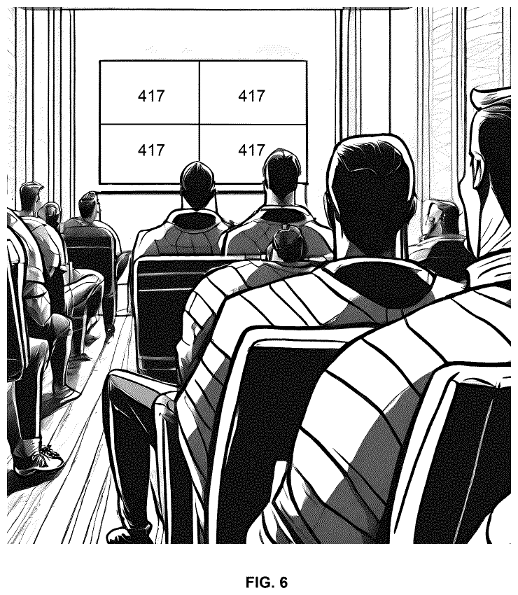

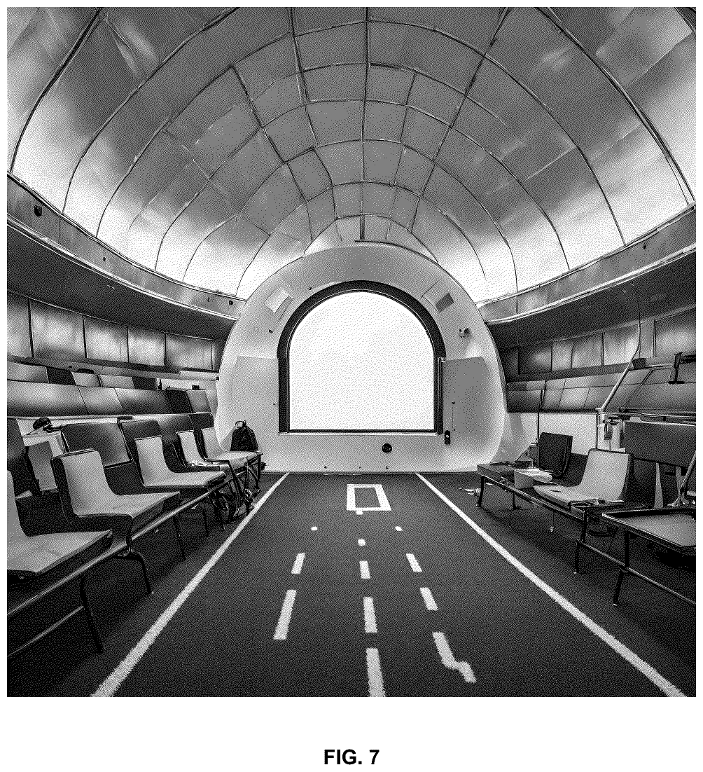

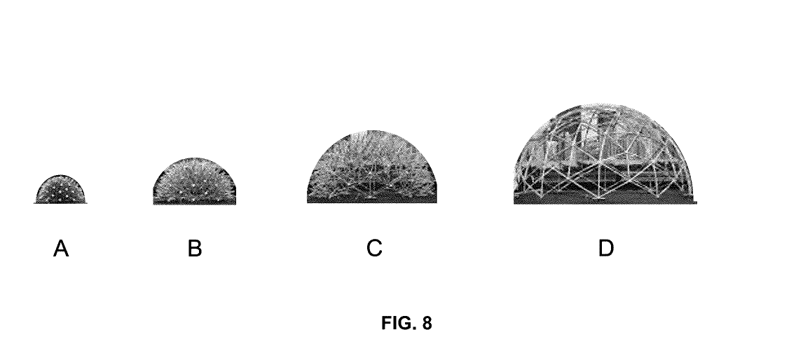

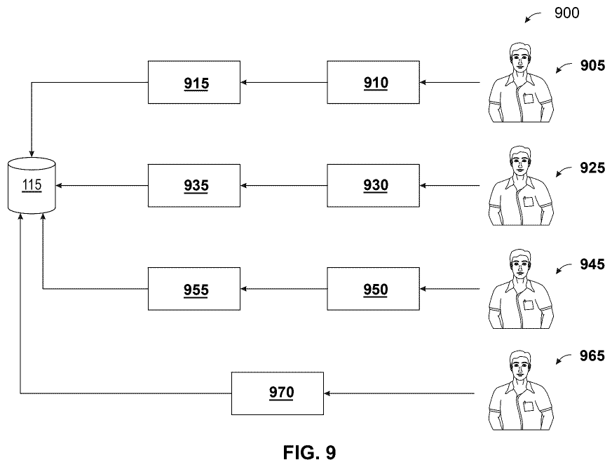

FIGS. 4-9 illustrate embodiments of a system 400 for training athletes. FIG. 4 illustrates a system 400 that may be deployed in various environments for mentoring/training athletes. FIG. 5 is an environmental view illustrating a pod that may be used by a coach to mentor an athlete in privacy. FIG. 6 is an environmental view illustrating coaches and athletes to reviewing film within a film room, wherein the coaches and players may manipulate what is presented on the screen via their respective mobile computing devices. FIG. 7 is an environmental view illustrating the interior of a portable pod on a football field that may be used to discuss game strategy. FIG. 8 illustrates a portable pod in a collapsed position (top) and an expanded position (bottom). FIG. 9 illustrates permission levels 900 that may be utilized by the system 400 for controlling access to user content 915, 935, 955 such as user data 430A, image data 430B, application data 430C, sports data 430D, diet data 430E, fitness data 430F, and student data 430G. It is understood that the various method steps associated with the methods of the present disclosure may be carried out as operations by the system 400 shown in FIGS. 4-8.

The system 400 generally comprises one or more computing devices 410 having user interfaces 411, processor 220 operably connected to said one or more computing devices 410, display 316 operably connected to said processor 220, and non-transitory computer-readable medium (CRM) 416 coupled to said processor 220 and having instructions stored thereon. Some preferred embodiments may further comprise a camera operably connected to said computing device 410. In one preferred embodiment, a database 115 may be operably connected to the processor 220 and the various data of the system 400 may be stored therein, including, but not limited to, user data 430A, image data 430B, application data 430C, sports data 430D, diet data 430E, fitness data 430F, and student data 430G. In some preferred embodiments, the display 316 may further comprise a display user interface 316A having a plurality of display windows configured to present the various data of the system 400 therein, wherein a control board 409 of the display 316 may be configured to receive said data and arrange it within the plurality of display windows. In yet another preferred embodiment, a wireless communication interface may allow the processors 220 of the system 400 to receive and transmit the various data of the system therebetween.

Though referred to as a single computing device 410 of a user 405, one with skill in the art will recognize that multiple computing devices 410 of multiple users may be used without departing from the inventive subject matter described herein. Additionally, though referred to as a single display, one with skill in the art will recognize that multiple displays may be linked together in a way that creates a “single” display that may be used in a manner without departing from the inventive subject matter described herein. For instance, four OLED televisions may be linked together in way that creates a multi-display that the system may use as a “single” display. Additionally, one with skill in the art will recognize that a plurality of displays may be controlled by a single control board, and the single control board may manage the plurality of display windows about the display user interfaces of the plurality of displays. In yet another preferred embodiment, two or more control boards of two or more displays may be operably connected to one another and manage the plurality of display windows about the display user interfaces of the plurality of displays in collaboration with one another. Accordingly, one with skill in the art will recognize that displays may be used in combination with one or more control boards and one or more computing devices in a number of ways without departing from the inventive subject matter described herein.

Generally, the system is designed to identify users of the system and facilitate communication between users, wherein at least one user is an athlete and at least one user is a mentor of said athlete. A mentor may be defined as a user who trains or advises another user. As used herein, a mentor may include, but is not limited to, athletic coaches, doctors, nurse practitioners, nurses, personal trainers, dieticians, tutors, or any combination thereof. In some preferred embodiments, athletes may qualify as mentors when taking on an advisory role to a tutee user. In a preferred embodiment, the system is used by one or more mentor users to mentor/advise one or more tutee users via information presented within a plurality of display windows of a display user interface of a display, wherein the information presented in the control windows is selected via the respective computing devices of the mentor user(s) and tutee user(s). This may allow for coaches to quickly discuss various aspects of an athlete's life by allowing the athlete and coach to quickly connect to a local display and choose information to discuss, including, but not limited to, tactics, performance, health, education, and other concerns. In some embodiments, the system may allow for remote communication between mentor users and tutee users as if they were working together in person. Accordingly, the various features of the system are not limited to situations in which the mentor user and tutee user are in close proximity to one another. In some embodiments, the system may be a part of a portable pod, which may allow the system to be transported to other facilities, such as athletics fields.

In a preferred embodiment, a control board 409 of the display 316 receives image data 430D from the computing entity 200. The control board 409 may then present said image data 430D via the display 316 in the display user interface 316A. In one preferred embodiment, the image data 430D is streamed/mirrored from the computing entity 200 to the control board 409, wherein the control board 409 inserts said streamed/mirrored image data 430D into the display user interface 316A. Alternatively, the control board 409 may manipulate the image data 430D and/or display user interface 316A based on commands received from an input device. In one preferred embodiment, the display user interface 316A may also comprise a control window, which may allow a user 405 to control the layout of the display user interface 316A. For instance, a user 405 may choose a layout that separates the display user interface 316A into multiple windows. Alternatively, an input device having a plurality of layouts thereon may be used to manipulate the layout of the display user interface 316A. The input device may be connected to the system 400 via a wired or wireless connection. In a preferred embodiment, the input device communicates sends a computer readable signal containing instructions to the control board 409, which the control board 409 uses to manipulate the image data 430D and/or display user interface 316A.

In a preferred embodiment, a user 405 logs into a user profile of the system before accessing the various features of a display, allowing the system to verify the identity of the user. A user interface 411 of a computing device 410 allows a user to input login credentials and/or commands. A processor 220 operably connected to said computing device and said display 316 sends the login credentials and/or commands to a control board of said display via a computer readable signal, wherein said login credentials and/or commands of said computer readable signal allow access to said display should they be associated with a user profile having sufficient permission levels. A user may then manipulate the user interface of the computing device in a way that allows said user to choose various data of the system to be presented on the display for the purpose of mentoring athletes. In some preferred embodiments, a user 405 may be required to use a secondary security method to access a display to present the various data of the system. For instance, a user 405 may be required to use a camera of their computing device 410 to scan a predefined pattern, such as a bar code or a QR code, that is presented on a display 316, which may associate that user with a particular display. In some embodiments, a secondary security method may also serve as a means as determining a location of a user using the system.

In a preferred embodiment, a system may choose remote communication via the user interface of a computing device. Preferably, a first user may select one or more other users with whom to communicate once remote communication has been selected. The system may then use a secondary security method to connect the users via displays. For instance, a mentor user may choose to communicate remotely with five tutee users via the user interface. The system may then require the mentor user and five tutee users to use a secondary security method to connect via a display device. In a preferred embodiment, the mentor user and five tutee users may be required to scan a QR code of a display device using a camera of their computing device, causing the system to associate each user with the display in which they scanned. The system may then operably connect the various displays and allow users of the system to transmit the various data of the system from their respective computing device to the control board to be displayed within the display windows of the displays. In a preferred embodiment, each display connected in this way displays the same content, which may or may not be organized within the display windows of the system in the same way. In one preferred embodiment, each control board of a display controls how the content is organized within display windows of the display user interface.

In some preferred embodiments, the system 400 may further comprise a secondary security device. Devices that may act as the secondary security device may include, but are not limited to, biometric devices, key cards, wearables, or any combination thereof. In a preferred embodiment, devices that may act as the biometric devices include but are not limited to contact biometric devices, such as fingerprint scanners and hand geometry scanners, and/or non-contact biometric devices, such as face scanners, iris scanners, retina scanners, palm vein scanners, and voice identification devices. In some embodiments, the secondary security device may be operably connected to the computing device 410 and/or display 316 in a way such that it is in direct communication with the computing device 410 and/or display 316 and no other computing device 410 and/or display 316. For instance, the secondary security device in the form of a facial recognition camera may be securely and directly connected to a control board 409 of the display 316 such that a user 405 must biometrically scan their face prior to the system allowing access to the various data of the system. In some preferred embodiments, biometric data associated with a user is saved in a user profile as user data, which the system uses to verify a user's identity. For instance, secondary security devices may be securely and directly connected to a first computing device and a second computing device in a way such that both a first user of the first computing device and a second user of the second computing device must biometrically scan thumbprints prior to the system allowing the first user and second user to access data of the system that may be protected by laws, including, but not limited to, Family Educational Rights and Privacy Act (FERPA), Protection of Pupil Rights Amendment (PPRA), and Children's Online Privacy Protection Rule (COPPA).

In a preferred embodiment, key cards and wearables preferably comprise a secure transmitter configured to transmit a login credentials to the computing device and/or control board of the display. Wearables having a secure transmitter include clothing and accessories, such as a T-shirt, pants, jacket, belt, shoes, wristband, watch, glasses, pin, nametag, etc., that has said transmitter attached thereto and/or incorporated therein. The secure transmitter preferably contains login credentials in the form of a unique ID, which may be conveyed to the computing device and/or control board of the display 316 in the form of a computer readable signal. Unique IDs contained within the computer readable signal that has been broadcast by the transmitter may include, but are not limited to, unique identifier codes, social security numbers, PINs, etc. For instance, a computer readable signal broadcast by a secondary security device in the form of a wrist band may contain information that will alert the control board of the display 316 that a particular user 405 is within a certain range, which may cause the system 400 to allow a user to access data of the system if additional steps are taken.

Types of devices that may act as the transmitter include, but are not limited, to near field communication (NFC), Bluetooth, infrared (IR), radio-frequency communication (RFC), radio-frequency identification (RFID), and ANT+, or any combination thereof. In an embodiment, transmitters may broadcast signals of more than one type. For instance, a transmitter comprising an IR transmitter and RFID transmitter may broadcast IR signals and RFID signals. Alternatively, a transmitter may broadcast signals of only one type of signal. For instance, student ID cards may be fitted with transmitters that broadcast NFC signals containing unique IDs associated with a particular user, wherein displays equipped with NFC receivers must receive said NFC signals containing unique IDs before access to one or more features of the display user interface may be granted.

Use of secondary security devices may be used solely or in addition to secondary security methods of the system, allowing the system to have flexible multifactor identification to suit the needs of its environment. Simultaneous use may be beneficial in situations where the system assists in managing athletes' various nutritional needs. For instance, a user may use a secondary security method for identification purposes, and the wearable may instruct the system as to what food options a user may choose from before the display and/or computing device presents said food options to the user. The user may then use the display and/or computing device to choose food, and the system may save diet data associated with the chosen food to the user profile of the user. A nutritionist having appropriate permissions may review the diet data to be sure that the athlete is conforming to a prescribed nutrition program.

In a preferred embodiment, the various data of the system 400 may be stored in user profiles 430. In a preferred embodiment, a user profile 430 is related to a particular user 405. A user 405 is preferably associated with a particular user profile 430 based on a username. However, it is understood that a user 405 may be associated with a user profile 430 using a variety of methods without departing from the inventive subject matter herein. Types of data that may be stored within user profiles 430 of the system 400 include, but are not limited to, user data 430A, image data 430B, application data 430C, sports data 430D, diet data 430E, fitness data 430F, and student data 430G. Some preferred embodiments of the system 400 may comprise a database 115 operably connected to the processor 220. The database 115 may be configured to store user data 430A, image data 430B, application data 430C, sports data 430D, diet data 430E, fitness data 430F, and student data 430G within said user profiles 430. As used herein, user data 430A may be defined as personal information of a user 405 that helps the system 400 identify the user 405. Types of data that may be used by the system 400 as user data 430A includes, but is not limited to, a user's name, username, social security number, student number, phone number, email address, physical address, gender, age, or any combination thereof.

As used herein, image data 430B may be defined as photographic or trace objects that represent the underlying pixel data of an area of an image element, which is created, collected, and stored using image constructor devices, such as a camera. For instance, the system may use image data obtained via a scanning device and/or a secondary security device to confirm the identity of a user. For instance, image data of sporting events may be transmitted to the display and presented to the user where it may be reviewed/manipulated by a user in preparation for a future sporting event. For instance, image data of a display application may be transmitted to the display from the computing device, server, and/or database where it may be manipulated by the control board within the plurality of display windows of the display user interface. In a preferred embodiment, the system 400 comprises one or more exterior cameras for recording image data 430B, which may then be stored for later review by the users 405. For instance, a coach desiring to review a scrimmage with a soccer team might record it with an exterior camera directly connected to the system 400 and use the image data 430 as supplementary footage. Accordingly, one with skill in the art will understand that image data 430B may be used by the system multiple ways to carry out various functions of the system without departing from the inventive subject matter described herein.

Application data 430C may be defined as instructions that cause a display application of the display to perform an action. In one preferred embodiment, the system may determine whether a user application of the computing device is compatible with a display application of the display. If it is determined that the display application and user application are compatible, application data may be transmitted to the display from the computing device in lieu of image data. The display application is controlled by the control board of the display and inserted into a display window of the display user interface. Instructions input into a compatible user application are transmitted to the control board from the computing device and are used by the control board to perform actions of the display application, reducing the amount of data transferred between the computing device and display. For instance, a display application version of playbook software and a user application version of said playbook software may be compatible in a way such that a user may open the user application on their computing device and subsequently instruct the system (via the user interface) to display the playbook software in a display window of the display user interface. The control board may then determine if the display application version of the playbook software is compatible with the user application version of the playbook software. If the display application version and user application version are compatible, the control board may open the display application version locally and manipulate it via instructions received from the computing device of the user as actions are taken via the user application. If the display application and user application are not compatible, the control board may receive image data of the user application and present it within a display window of the display user interface.

Sports data 430D may be defined as information pertaining to an activity involving physical exertion and skill in which an individual or team competes against another or others for entertainment. Types of data that may be used as sports data includes, but is not limited to, sport genre, statistics, analytics, tutorials, playbooks, sporting event video, film analysis, coach's notes, player's notes, or any combination thereof. Diet data 430E may be defined as information pertaining to the food and drink intake of a tutee user. Diet data may include one or more threshold values for the various nutrients and micronutrients that a particular user may be required to intake for peak performance. For instance, dietary data may comprise a minimum threshold and maximum threshold for a total amount of calories a tutee user should consume in day. In some preferred embodiments, the system may be used to track food and beverage ingested by a tutee user. Fitness data 430F may be defined as information pertaining to physical performance of a tutee user. Types of data that may be used as fitness data includes, but is not limited to, workout routines, tutorials, statistics, analytics, or any combination thereof. Student data 430G may be defined as information pertaining to the academic performance of a tutee user. Types of data that may be used as student data includes, but is not limited to, grades, transcripts, class lists, student course schedules, health records, student financial information, student discipline files, or any combination thereof.

As previously mentioned, some preferred embodiments of the display 316 may further comprise a control board 409. The control board 409 comprises at least one circuit and microchip. In another preferred embodiment, the control board 409 may further comprise a wireless communication interface, which may allow the control board 409 to receive instructions from an input device controlled by a user 405. In a preferred embodiment, the control board 409 may control the plurality of display windows of the display user interface 316A. The microchip of the control board 409 comprises a microprocessor and memory. In another preferred embodiment, the microchip may further comprise a wireless communication interface in the form of an antenna. The microprocessor may be defined as a multipurpose, clock driven, register based, digital-integrated circuit which accepts binary data as input, processes it according to instructions stored in its memory, and provides results as output. In a preferred embodiment, the microprocessor may receive the various data of the system from a server 110 and/or database 115 via the wireless communication interface.

As mentioned previously, the system 400 may comprise a user interface 411. A user interface 411 may be defined as a space where interactions between a user 405 and the system 400 may take place. In an embodiment, the interactions may take place in a way such that a user 405 may control the operations of the system 400. A user interface 411 may include, but is not limited to operating systems, command line user interfaces, conversational interfaces, web-based user interfaces, zooming user interfaces, touch screens, task-based user interfaces, touch user interfaces, text-based user interfaces, intelligent user interfaces, brain-computer interfaces (BCIs), and graphical user interfaces, or any combination thereof. The system 400 may present data of the user interface 411 to the user 405 via a display 316 operably connected to the processor 220. A display 316 may be defined as an output device that communicates data that may include, but is not limited to, visual, auditory, cutaneous, kinesthetic, olfactory, and gustatory, or any combination thereof.

In a preferred embodiment, the control board 409 of the display 316 receives image data from the computing device, server 110, and/or database 115 and may then present said image data 430D via at least one display window of the display user interface 316A of a display 316, as illustrated in FIGS. 4-8. In a preferred embodiment, image data 430D is streamed/mirrored from the computing device, database 115, and/or server 110 to the control board 409, wherein the control board 409 inserts said streamed/mirrored image data 430D into said at least one display window. Alternatively, the control board 409 may automatically select a layout of the display user interface 316A, wherein said layout may be determined based on a plurality of variables, including, but not limited to, number of users, type of content 815, 835, 855 being viewed by the user(s) 405, user preferences, user location, or any combination thereof. For instance, the control board 409 may select a layout of a display user interface 316A comprising a split screen having two display windows configured to present a student athlete's grades in a first display window and a student athlete's attendance record in a second display window, wherein the users 405 (mentor user and tutee user) were identified via their respective computing devices (a first computing device and a second computing device) prior to displaying protected information. For instance, the control board 409 may select a layout of a display user interface 316A comprising a split screen having two display windows and communication window, wherein a user is presented in the communication window, wherein first image data selected by the first user via a first computing device is presented in a first display window, and wherein second image data selected by the second user via a second computing device is presented in a second display window. This may allow coaches, assistants, and other personnel of an athletic program to instruct athletes remotely.

Information presented via a display 316 may be referred to as a soft copy of the information because the information exists electronically and is presented for a temporary period of time. Information stored on the non-transitory computer-readable medium 416 may be referred to as the hard copy of the information. For instance, a display 316 may present a soft copy of visual information via a liquid crystal display (LCD), wherein the hardcopy of the visual information is stored on a local hard drive. For instance, a display 316 may present a soft copy of audio information via a speaker, wherein the hard copy of the audio information is stored in RAM. For instance, a display 316 may present a soft copy of tactile information via a haptic suit, wherein the hard copy of the tactile information is stored within a database 115. Displays 316 may include, but are not limited to, cathode ray tube monitors, LCD monitors, light emitting diode (LED) monitors, gas plasma monitors, screen readers, speech synthesizers, haptic feedback equipment, virtual reality headsets, speakers, and scent generating devices, or any combination thereof.

The database 115 may be operably connected to the processor 220 via wired or wireless connection. In a preferred embodiment, the database 115 is configured to store user data 430A, image data 430B, application data 430C, sports data 430D, diet data 430E, fitness data 430F, and student data 430G within user profiles 430. Alternatively, the user data 430A, image data 430B, application data 430C, sports data 430D, diet data 430E, fitness data 430F, and student data 430G may be stored within user profiles 430 on the non-transitory computer-readable medium 416. The database 115 may be a relational database such that the user data 430A, image data 430B, application data 430C, sports data 430D, diet data 430E, fitness data 430F, and student data 430G associated with each user profile 430 within the plurality of user profiles 430 may be stored, at least in part, in one or more tables. Alternatively, the database 115 may be an object database such that user data 430A, image data 430B, application data 430C, sports data 430D, diet data 430E, fitness data 430F, and student data 430G associated with each user profile 430 of the plurality of user profiles 430 may be stored, at least in part, as objects. In some instances, the database 115 may comprise a relational and/or object database and a server 110 dedicated solely to managing the user data 430A, image data 430B, application data 430C, sports data 430D, diet data 430E, fitness data 430F, and student data 430G in the manners disclosed herein.

AI generated plan specific to the student. Maybe use QR code in some ways.

As previously mentioned, some embodiments of the system may further comprise a pod. In one preferred embodiment, the pod is portable and comprises a framework and exterior shell. In some embodiments, the portable pod may also comprise at least one hydraulic/pneumatic arm operably connected to said exterior shell and/or framework, which may be used to expand or contract the portable pod. In embodiments comprising a hydraulic/pneumatic arm, the framework is configured to expand until it reaches an extended position as the hydraulic/pneumatic arm extends, wherein an extended hydraulic/pneumatic arm coincides with the portable pod being placed in an extended position. In some embodiments, the frame and/or exterior shell may comprise joints. Joints of the portable pod may allow said portable pod to take on the various shapes described herein. In one preferred embodiment, the joints of the framework and/or exterior shell are a plurality of prismatic revolute joints that create an isokinetic structure that can take on a much smaller size when placed in the collapsed position compared to when placed in the extended position. For instance, as illustrated in FIG. 8, a portable pod in the form of isokinetic structures may be brought to a stadium in a collapsed position (A) before being placed in an extended position (D) to be as an on-field instructional room for athletes during a game. In another preferred embodiment, the joints may act in conjunction with a gear and pulley system 400, such as a block and tackle, to pull the move the various pieces of the frame and/or exterior shell until the portable pod is placed in an extended position. In another preferred embodiment, the portable pod comprises one or more inflatable segments that, upon inflation, form the exterior frame of the pod. In such an embodiment, the pod remains in a generally collapsed position until the inflatable segments are inflated sequentially or simultaneously, at which point the pod automatically assumes the appropriate shape.

In yet another preferred embodiment, the portable pod in its collapsed position is transported in a case or other container from one location to another. In such an embodiment, the user is enabled to ensure the system 400 is accessible regardless of location and the same system can be used and reused by the same users at the most appropriate locale. In another preferred embodiment, the portable is configured to fit about the base of a trailer or truck bed, simplifying the transport process and potentially rendering moot the need to put the portable pod in its compact configuration. In yet another preferred embodiment, the portable pod is configured to fit about the base of a boat or ship, allowing transport and utilization of the system 400 in aquatic or maritime environments. In such an embodiment, the system could be used near or at the training sites of distance swimmers, triathletes, and divers. In still another preferred embodiment, the portable pod comprises a tether or other affixing means by which a helicopter may lift and transport it from one location to another. This function would permit the portable pod and by extension the full system 400 to be utilized in locations that land vehicles could only approach with difficulty, such as a remote, high-elevation campsite.

The display 316 of the system 400 is preferably connected to the frame and/or exterior shell in a way such that a user 405 may view the display 316 only from the interior of the portable pod. Due to the folding nature of the system 400, the display 316 preferably comprises a flexible screen. Types has displays 316 that may function as a flexible screen, include, but are not limited to, electronic ink, Gyricon, Organic LCD, and OLED, or any combination thereof. In other preferred embodiments, the portable pod may comprise furniture and/or devices, including, but not limited to, desks, chairs, computing devices, or any combination thereof. The system may be used within the portable pods to allow mentor users and tutee users to interact. For instance, a portable pod comprising a first display having a control board and display user interface may be placed on the sidelines of a football field and deployed into an open position. A first coach located on the sidelines may operably connect a first computing device to the first computing device and a second coach located in a sky box may operably connect a second computing device to a second display. The first coach and second coach may select (via their respective computing devices) data to present on the displays, and athletes within the portable pod may view the content presented thereon, including a communication window that may facilitate communication between the first coach/athletes within the tent and the second coach within the box. In some preferred embodiments, the athletes may use computing devices operably connected to the display to interact with the coaches by manipulating data/display windows presented on said display.

In a preferred embodiment, the portable pod comprises a plurality of seats that may be used by athletes or mentors while they conduct their business in said pod. These seats may be integrated into the structure of the portable pod or added separately according to the requirements of the users 405. For instance, a pod might comprise one or more flat planes attached to the side of the pod by a hinge that can unfold to a specific angle to form a seat parallel with the ground. When the pod is in its collapsed position, these seats might fold up against the walls of the pod to be seamlessly integrated into a collapsed position. In another preferred embodiment, the portable pod lacks built-in seating arrangements but comprises one or more recesses about the perimeter of the frame into which seats might be placed. In yet another preferred embodiment, the pod does not have any structures specifically designed to accommodate seating, but the interior is spacious enough to include ordinary seating, which may be brought into the pod as needed.

The portable pod may comprise any number of features and functions that enhance its utility as an enclosure for the training of athletes. In a preferred embodiment, the portable pod is waterproof and constructed to be resilient against a variety of weather conditions. In another preferred embodiment, the portable pod comprises a heating or air conditioning unit. These temperature controlling units may be controlled by the system 400 or operated manually. In yet another preferred embodiment, the portable pod comprises a dehumidifier. In still another preferred embodiment, the portable pod comprises an oxygen tank for situations involving high-altitude training conditions. Generally, it is recommended that the portable pod incorporate features that create an interior environment conducive to the training of athletes.

In a preferred embodiment, the system 400 is used for monitoring the training of athletic groups other than student athletes. For instance, the system 400 might be used to monitor the training of professional athletic teams, obviating the need for academic data collection and tracking. Alternatively, the system 400 might be used to monitor the progress of an amateur sports team or league. In another preferred embodiment, the system 400 is used for the athletic and academic training of specialized military personnel. For instance, sniper training typically necessitates both intensive physical conditioning and rigorous education in physics and firearms engineering. The system 400 could therefore be easily repurposed to assist military trainers in monitoring a prospective sniper's progress. Similarly, military engineers or medics might have their physical and academic progress monitored by the system 400 utilized by training personnel. In yet another preferred embodiment, the system 400 is applied for scientific purposes. For instance, an exercise scientist attempting to determine the efficacy of a diet, treatment, or training regimen on athletic development might use the system 400 as a mobile facility for managing the data of a plurality of subjects. In such an embodiment, the system 400 might comprise software for statistical analysis and graph generation.

To prevent un-authorized users from accessing the information of other user's 405, the system 400 may employ a digital security method. As illustrated in FIG. 9, the digital security method of the system 400 may comprise a plurality of permission levels 900 that may grant users 405 access to user content 915, 935, 955 within the database 115 while simultaneously denying users 405 without appropriate permission levels 900 the ability to view user content 915, 935, 955. To access the user content 915, 935, 955 stored within the database 115, users 405 may be required to make a request via a user interface 411. Access to the data within the database 115 may be granted or denied by the processor 220 based on verification of a requesting user's 905, 925, 945 permission level 900. If the requesting user's 905, 925, 945 permission level 900 is sufficient, the processor 220 may provide the requesting user 905, 925, 945 access to user content 915, 935, 955 stored within the database 115. Conversely, if the requesting user's 905, 925, 945 permission level 900 is insufficient, the processor 220 may deny the requesting user 905, 925, 945 access to user content 915, 935, 955 stored within the database 115. In an embodiment, permission levels 900 may be based on user roles 910, 930, 950 and administrator roles 970, as illustrated in FIG. 9. User roles 910, 930, 950 allow requesting users 905, 925, 945 to access user content 915, 935, 955 that a user 405 has uploaded and/or otherwise obtained through use of the system 400. Administrator roles 970 allow administrators 965 to access system 400 wide data.

In an embodiment, user roles 910, 930, 950 may be assigned to a user in a way such that a requesting user 905, 925, 945 may view user profiles 425 containing user data 430A, image data 430B, application data 430C, sports data 430D, diet data 430E, fitness data 430F, and student data 430G via a user interface 411. To access the data within the database 115, a user 405 may make a user request via the user interface 411 to the processor 220. In an embodiment, the processor 220 may grant or deny the request based on the permission level 900 associated with the requesting user 905, 925, 945. Only users 405 having appropriate user roles 910, 930, 950 or administrator roles 970 may access the data within the user profiles 425. For instance, as illustrated in FIG. 9, requesting user 1 905 has permission to view user 1 content 915 and user 2 content 935 whereas requesting user 2 925 only has permission to view user 2 content 935. Alternatively, user content 915, 935, 955 may be restricted in a way such that a user may only view a limited amount of user content 915, 935, 955. For instance, requesting user 3 945 may be granted a permission level 900 that only allows them to view user 3 content 955 related to diet data 430E but not user 3 content 955 related to student data 430G. In the example illustrated in FIG. 9, an administrator 965 may bestow a new permission level 900 on users so that it may grant them greater permissions or lesser permissions. For instance, an administrator 965 may bestow a greater permission level 900 on other users so that they may view user 3's content 955 and/or any other user's 405 content 915, 935, 955. Therefore, the permission levels 900 of the system 400 may be assigned to users 405 in various ways without departing from the inventive subject matter described herein.

The subject matter described herein may be embodied in systems, apparatuses, methods, and/or articles depending on the desired configuration. In particular, various implementations of the subject matter described herein may be realized in digital electronic circuitry, integrated circuitry, specially designed application specific integrated circuits (ASICs), computer hardware, firmware, software, and/or combinations thereof. These various implementations may include implementation in one or more computer programs that may be executable and/or interpretable on a programmable system including at least one programmable processor, which may be special or general purpose, coupled to receive data and instructions from, and to transmit data and instructions to, a storage system, and at least one peripheral device.

These computer programs, which may also be referred to as programs, software, applications, software applications, components, or code, may include machine instructions for a programmable processor, and may be implemented in a high-level procedural and/or object-oriented programming language, and/or in assembly machine language. As used herein, the term “non-transitory computer-readable medium” refers to any computer program, product, apparatus, and/or device, such as magnetic discs, optical disks, memory, and Programmable Logic Devices (PLDs), used to provide machine instructions and/or data to a programmable processor, including a non-transitory computer-readable medium that receives machine instructions as a computer-readable signal. The term “computer-readable signal” refers to any signal used to provide machine instructions and/or data to a programmable processor. To provide for interaction with a user, the subject matter described herein may be implemented on a computer having a display device, such as a cathode ray tube (CRD), liquid crystal display (LCD), light emitting display (LED) monitor for displaying information to the user and a keyboard and a pointing device, such as a mouse or a trackball, by which the user may provide input to the computer. Displays 316 may include, but are not limited to, visual, auditory, cutaneous, kinesthetic, olfactory, and gustatory displays, or any combination thereof.

Other kinds of devices may be used to facilitate interaction with a user as well. For instance, feedback provided to the user may be any form of sensory feedback, such as visual feedback, auditory feedback, or tactile feedback; and input from the user may be received in any form including, but not limited to, acoustic, speech, or tactile input. The subject matter described herein may be implemented in a computing system that includes a back-end component, such as a data server, or that includes a middleware component, such as an application server, or that includes a front-end component, such as a client computer having a graphical user interface or a Web browser through which a user may interact with the system described herein, or any combination of such back-end, middleware, or front-end components. The components of the system may be interconnected by any form or medium of digital data communication, such as a communication network. Examples of communication networks may include, but are not limited to, a local area network (“LAN”), a wide area network (“WAN”), metropolitan area networks (“MAN”), and the internet.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For instance, the implementations described above can be directed to various combinations and subcombinations of the disclosed features and/or combinations and subcombinations of several further features disclosed above. In addition, the logic flow depicted in the accompanying figures and/or described herein do not necessarily require the particular order shown, or sequential order, to achieve desirable results. It will be readily understood to those skilled in the art that various other changes in the details, devices, and arrangements of the parts and method stages which have been described and illustrated in order to explain the nature of this inventive subject matter can be made without departing from the principles and scope of the inventive subject matter.

What is claimed is:

What is claimed is:

1. A system for a portable pod comprising:
a framework operably connected to a hydraulic/pneumatic arm,
wherein said hydraulic/pneumatic arm alters a position of said framework;
an exterior shell connected to said framework,
wherein said exterior shell forms an exterior structure that protects an internal cavity created by said framework when said hydraulic/pneumatic arm causes said framework to be placed into an extended position,
wherein an opening within said exterior shell allows for access to said internal cavity;
a control board configured to manipulate a plurality of display windows of a display user interface;
a display operably connected to said control board,
wherein said display is secured in the interior of said internal cavity,
wherein said display is configured to present said display user interface having said plurality of display windows,
wherein said control board manipulates said plurality of display windows of said display user interface presented on said display,
wherein content related to athletic training is presented within said plurality of display windows;
a processor operably connected to said control board; and,
a non-transitory computer-readable medium coupled to said processor,
wherein said non-transitory computer-readable medium contains instructions stored thereon, which, when executed by said processor, cause said processor to perform operations comprising:
determining an identity of a user accessing a user profile via said user interface of said control board,
retrieving a user profile having user data that pertains to said identity, transmitting a permission level of said user profile to said control board, determining to which said content said user has access based on said permission level,
presenting, via said display, data pertaining to said user profile within said plurality of display windows,
organizing, via said control board, said plurality of display windows.

2. The system of claim 1, further comprising a hydraulic/pneumatic pack operably connected to said hydraulic/pneumatic arm and said control board,
wherein said control board is configured to manipulate said hydraulic/pneumatic pack,
wherein said hydraulic/pneumatic pack causes said hydraulic/pneumatic arm to move said framework from a collapsed position to said extended position.

3. The system of claim 2, further comprising a computing device having a user interface and operably connected to said control board and said processor.

4. The system of claim 3, wherein said user interface of said computing device allows a user to control said hydraulic/pneumatic pack in a way such that said user may cause said hydraulic/pneumatic pack to place said framework in said collapsed position and said extended position.

5. The system of claim 4, wherein said computing device allows a user to transmit image data to said display, wherein said display may present said image data within a display user interface.

6. The system of claim 5, further comprising a secondary security device operably connected to said control board,
wherein said secondary security device is configured to only communicate with said control board.

7. The system of claim 6, wherein said secondary security device is configured to send a computer readable signal to said control board, wherein said computer readable signal is used by said control board to verify login credentials of a user, wherein said login credentials allow said user to access said display user interface of said display.

8. A system for a portable pod comprising:
a first framework operably connected to a first hydraulic/pneumatic arm,
wherein said first hydraulic/pneumatic arm alters a position of said first framework;
a second framework operably connected to a second hydraulic/pneumatic arm,
wherein said second hydraulic/pneumatic arm alters said position of said second framework;
an exterior shell connected to said first framework and said second framework,
wherein said exterior shell forms an exterior structure,
wherein a shape of said exterior structure is manipulated by said position of said first framework relative to said second framework, and
wherein an opening within said exterior shell allows for access to an internal cavity created when at least one of said first framework or said second framework are placed in said extended position;
a control board configured to manipulate a plurality of display windows of a display user interface;
a display operably connected to said computing device and said control board,
wherein said display is secured in the interior of said internal cavity,
wherein said display is configured to present said display user interface having said plurality of display windows,
wherein said control board manipulates said plurality of display windows of said display user interface presented on said display,
wherein content related to athletic training is presented within said plurality of display windows;
a processor operably connected to said control board and computing device; and,
a non-transitory computer-readable medium coupled to said processor,
wherein said non-transitory computer-readable medium contains instructions stored thereon, which, when executed by said processor, cause said processor to perform operations comprising:
determining an identity of a user accessing a user profile via said user interface of said control board,
retrieving a user profile having user data that pertains to said identity,
transmitting a permission level of said user profile to said control board,
determining to which said content said user has access based on said permission level,
presenting, via said display, data pertaining to said user profile within said plurality of display windows,
organizing, via said control board, said plurality of display windows.

9. The system of claim 8, further comprising a hydraulic/pneumatic pack operably connected to said control board and at least one of said first hydraulic/pneumatic arm or said second hydraulic/pneumatic arm,
wherein said control board is configured to manipulate said hydraulic/pneumatic pack,
wherein said hydraulic/pneumatic pack causes at least one of said first hydraulic/pneumatic arm or said second hydraulic/pneumatic arm to move said frameworks from a collapsed position to an extended position,
wherein a locking mechanism secures said first framework in said position relative to said second framework.

10. The system of claim 9, further comprising a computing entity having a user interface and operably connected to said control board and said processor.

11. The system of claim 10, wherein said user interface of said computing entity allows a user to control said hydraulic/pneumatic pack in a way such that said user may cause said hydraulic/pneumatic pack to place said frameworks in said collapsed position and said extended position.

12. The system of claim 11, wherein said computing entity allows a user to transmit image data to said display, wherein said display may present said image data within a display user interface.

13. The system of claim 10, further comprising a secondary security device operably connected to said control board,
wherein said secondary security device is configured to only communicate with said control board.

14. A system for a portable pod comprising,
a plurality of Hoberman linkages;
a hydraulic/pneumatic arm operably connected to said plurality of Hoberman linkages,
wherein said hydraulic/pneumatic arm alters a position of said plurality of Hoberman linkages;
an exterior shell connected to said plurality of Hoberman linkages,
wherein said exterior shell forms an exterior structure over said plurality of Hoberman linkages to create a isokinetic building structure,
wherein an opening within said exterior shell allows for access to an internal cavity created when said plurality of Hoberman linkages are placed in an extended position;
a control board configured to manipulate a plurality of display windows of a display user interface;
a display operably connected to said computing device and said control board,
wherein said display is secured in the interior of said internal cavity,
wherein said display is configured to present said display user interface having said plurality of display windows,
wherein said control board manipulates said plurality of display windows of said display user interface presented on said display,
wherein content related to athletic training is presented within said plurality of display windows;
a processor operably connected to said control board and computing device; and,
a non-transitory computer-readable medium coupled to said processor,
wherein said non-transitory computer-readable medium contains instructions stored thereon, which, when executed by said processor, cause said processor to perform operations comprising:
determining an identity of a user accessing a user profile via said user interface of said control board,
retrieving a user profile having user data that pertains to said identity,
transmitting a permission level of said user profile to said control board, determining to which said content said user has access based on said permission level,
presenting, via said display, data pertaining to said user profile within said plurality of display windows,
organizing, via said control board, said plurality of display windows.

15. The system of claim 14, a hydraulic/pneumatic pack operably connected to said control board and to said hydraulic/pneumatic arm,
wherein said control board is configured to manipulate said hydraulic/pneumatic pack,
wherein said hydraulic/pneumatic pack causes said hydraulic/pneumatic arm to move said plurality of Hoberman linkages from a collapsed position to an extended position.

16. The system of claim 15, further comprising a computing entity having a user interface and operably connected to said control board.

17. The system of claim 16, wherein said user interface of said computing entity allows a user to control said hydraulic/pneumatic pack in a way such that said user may cause said hydraulic/pneumatic pack to place said plurality of Hoberman linkages in said collapsed position and said extended position.

18. The system of claim 16, wherein said computing entity allows a user to transmit image data to said display, wherein said display may present said image data within a display user interface.

19. The system of claim 15, further comprising a secondary security device operably connected to said control board,
wherein said secondary security device is configured to only communicate with said control board.
The system of claim 19, wherein said secondary security device is configured to collect biometric data from a user, wherein said biometric data is used by said control board to verify login credentials of said user, wherein said login credentials allow said user to access a display user interface of said display.
